(19) United States
(12) Patent Application Publication
(10) Pub. No.: US 2024/0092430 A1
(43) Pub. Date: Mar. 21, 2024

(54) Rear Structure for a Motor Vehicle and Motor Vehicle Comprising Such a Rear Structure

(71) Applicant: Bayerische Motoren Werke Aktiengesellschaft, Muenchen (DE)

(72) Inventors: Manuel ANASENZL, Mainburg (DE); Moritz FRENZEL, Muenchen (DE); Christian HASLAUER, Starnberg (DE); Daniel HEIM, Neufahrn (DE); Maximilian JUENGLING, Muenchen (DE); Manuel RIEDL, Weil (DE); Andre SCHAEFER, Rottenburg a.d.Laaber (DE); Marcel STERZENBACH, Essenbach (DE)

(21) Appl. No.: 18/274,383

(22) PCT Filed: Mar. 15, 2022
(86) PCT No.: PCT/EP2022/056677

§ 371 Date: Jul. 26, 2023

(30) Foreign Application Priority Data
Apr. 20, 2021 (DE) 10 2021 109 894.7
Feb. 4, 2022 (DE) 10 2022 102 703.1

(51) Int. Cl. B62D 25/08; B62D 25/16; B62D 29/00

(52) U.S. Cl. CPC B62D 25/087; B62D 25/088; B62D 25/16; B62D 29/008

(57) ABSTRACT

A rear structure for a motor vehicle includes two longitudinal members, a front cross member and a rear cross member. The front cross member and the rear cross member connect the longitudinal members to one another. The rear structure is a single-piece die-cast component. A motor vehicle includes such a rear structure.

### BACKGROUND AND SUMMARY

The present invention relates to a rear structure for a motor vehicle and to a motor vehicle having such a rear structure.

Rear structures for motor vehicles are known in various embodiments from the prior art.

DE 10 2020 214 105 A1 describes a rear structure for a motor vehicle having two longitudinal members, which extend in the motor vehicle longitudinal direction, and two crossmembers. The crossmembers extend in the motor vehicle transverse direction and connect the longitudinal members to one another. For this purpose, the longitudinal members each comprise a large number of lateral fastening portions via which the longitudinal members are connected to the crossmembers.

The assembly of the rear structure described in DE 10 2020 214 105 A1 proves to be complicated owing to the large number of lateral fastening portions.

It is therefore an object of the present invention to provide a rear structure for a motor vehicle requiring little assembly effort. It is also an object of the present invention to provide a motor vehicle comprising such a rear structure.

This object is achieved according to the invention by a rear structure and by a motor vehicle, in accordance with the independent claims.

According to the invention, there is thus proposed a rear structure for a motor vehicle which comprises two longitudinal members, a front crossmember and a rear crossmember. The front crossmember and the rear crossmember each connect the longitudinal members to one another. The rear structure is a single-piece die-cast component.

The core idea of the invention is thus to configure the rear structure in one piece by means of die casting. No assembly effort is therefore required for the rear structure, in particular for connecting the crossmembers to the longitudinal members.

The rear structure is, for example, a constituent part of a body of the motor vehicle.

The longitudinal members can, for example, be connected at their front end in the motor vehicle longitudinal direction to a rear end of a side rocker panel of the motor vehicle.

In a functional installation state of the rear structure on the motor vehicle, the longitudinal members can thus each adjoin a side rocker panel to the rear in the motor vehicle longitudinal direction.

For example, in a functional installation state of the rear structure on the motor vehicle, the two longitudinal members extend at least largely in the motor vehicle longitudinal direction and are spaced apart from one another in the motor vehicle transverse direction.

In a functional installation state of the rear structure on the motor vehicle, the front crossmember and the rear crossmember can extend in the motor vehicle transverse direction. The front crossmember and the rear crossmember can be spaced apart from one another in the motor vehicle longitudinal direction.

For example, in each case a rocker panel of the motor vehicle can be connected to a spring support of the motor vehicle by means of the longitudinal members.

In a preferred embodiment, the rear structure according to the invention comprises an extension of the longitudinal members.

In a functional installation state of the rear structure on the motor vehicle, the extensions of the longitudinal members each adjoin a respective one of the longitudinal members to the rear in the motor vehicle longitudinal direction.

In an exemplary embodiment, the rear structure according to the invention comprises a first cutout in which a luggage compartment floor of the motor vehicle can be arranged.

The first cutout can be delimited laterally, that is to say in the motor vehicle transverse direction, by the longitudinal members. In the motor vehicle longitudinal direction, the first cutout can be delimited to the front by the front crossmember and to the rear by the rear crossmember. That is to say that the longitudinal members, the front crossmember and the rear crossmember define the first cutout laterally.

The first cutout is, for example, at least approximately cuboidal.

In a top view, the first cutout can thus be at least approximately rectangular.

The first cutout is, for example, free from connection webs which extend from the longitudinal members, the front crossmember and/or the rear crossmember.

In an exemplary embodiment, the rear structure according to the invention comprises a rear covering support.

In a functional installation state of the rear structure on the motor vehicle, the rear covering support can extend in the motor vehicle transverse direction.

In particular in the motor vehicle transverse direction, the rear covering support can at its end sides adjoin rear end regions of the extensions of the longitudinal members in the motor vehicle longitudinal direction. The rear covering support can thus connect the extensions of the longitudinal members to one another.

In a preferred embodiment, the rear structure according to the invention comprises a second cutout.

The second cutout is delimited laterally for example by the extensions of the longitudinal members. To the front in the motor vehicle longitudinal direction, the second cutout is delimited for example by the rear crossmember.

The second cutout can be open to the rear in particular in the motor vehicle longitudinal direction.

The extensions of the longitudinal members can each have a connection element to the rear in the motor vehicle longitudinal direction on which a rear covering support of the motor vehicle can be fixed. The rear covering support is, for example, not a constituent part of the rear structure. The second cutout can be closed to the rear in the motor vehicle longitudinal direction by means of the rear covering support.

In a preferred embodiment, the rear structure according to the invention comprises extensions of the longitudinal members which, in a functional installation state of the rear structure on the motor vehicle, each adjoin a respective one of the longitudinal members to the rear in the motor vehicle longitudinal direction, and a rear covering support. The rear covering support connects the extensions of the longitudinal members to one another. The extensions of the longitudinal members, the rear crossmember and the rear covering support define a second cutout in which a luggage compartment tray of the motor vehicle can be arranged. To the rear in the motor vehicle longitudinal direction, the second cutout is thus delimited by the rear covering support, which is a constituent part of the rear structure.

In a preferred embodiment, the rear structure according to the invention comprises a rear covering.

The rear covering support and the rear covering can be formed in one piece, that is to say together form a single component.

A luggage compartment tray, which delimits the interior of the motor vehicle on an underside, can be arranged for example in the second cutout.

The luggage compartment tray can be formed in one or more parts.

The second cutout is, for example, at least approximately cuboidal.

In a top view, the second cutout can thus be at least approximately rectangular.

In a functional installation state of the rear structure on the motor vehicle, the second cutout can be arranged behind the first cutout in the motor vehicle longitudinal direction.

The second cutout can be free from connection webs which extend from side walls which define the cutout, that is to say from the extensions of the longitudinal members, from the rear crossmember and/or the rear covering support.

In a functional installation state of the rear structure on the motor vehicle, the rear covering can adjoin the rear covering support to the rear in the motor vehicle longitudinal direction.

In an exemplary embodiment, the rear structure according to the invention comprises wheelhouses, in particular rear wheelhouses or at least parts of wheelhouses.

In a preferred embodiment, the rear structure according to the invention comprises spring supports. The spring supports each form an attachment point to the chassis. In particular, spring struts of the motor vehicle can be fastened to the spring supports.

In a preferred embodiment, the rear structure according to the invention is an aluminum die-cast component, that is to say a component made of aluminum, produced by the aluminum being pressed into a preheated mold in the liquid or pasty state under high pressure.

In a preferred embodiment, the rear structure according to the invention is numerically structure-optimized, that is to say computer-simulated by means of a numerical method, in particular with the aim of improving specific values, such as, for example, its stiffness, its acoustic excitation and/or its strength.

The rear structure can, for example, be parameter-optimized, shape-optimized and/or topology-optimized.

The parameter optimization concerns the question of which dimensions, direction, arrangement and/or materials and material qualities are required of in particular structural elements of the rear structure in order to achieve specific target values. Here, individual parameters, for example the cross section of a beam element or the wall thickness of a shell element, are varied.

The shape optimization is carried out to achieve specific target values. This occurs by adapting the shape of the rear structure, in particular the shape of at least one aperture, at least one embossing and/or at least one rib, for example to minimize stress peaks in the structural mechanics of the rear structure. Here, geometric parameters of local regions of the rear structure are deformed in such a way that the stresses are distributed more uniformly and thus the stress peaks are minimized.

The geometric parameters can comprise component dimensions, radii of holes and curvature and/or position of holes and curvature.

The shape optimization can occur by means of a vertex morphing algorithm.

The topology optimization relates to an optimum material distribution in a predetermined design space such that the rear structure satisfies a set target value or set target values with minimum use of material or the target values are improved with a fixed amount of material. For this purpose, an adapted framework is worked out from the rear structure in that, during each iteration step, slightly loaded material is avoided or redistributed. During the topology optimization, what is thus sought is the most material-saving support structure from different variants that at the same time satisfies the target values for the rear structure or has the best target values with a fixed amount of material.

Furthermore, the invention relates to a motor vehicle comprising a rear structure as described above.

The motor vehicle can comprise a body which comprises the rear structure as described above.

The invention will be explained in more detail below on the basis of exemplary embodiments illustrated in the drawings.

### BRIEF DESCRIPTION OF THE DRAWINGS

FIG. 1 is a perspective view of a first rear structure according to the invention;

FIG. 2 is a top view of the first rear structure according to the invention;

FIG. 3 is a top view of a second rear structure according to the invention; and

FIG. 4 is a top view of a third rear structure according to the invention.

### DETAILED DESCRIPTION OF THE DRAWINGS

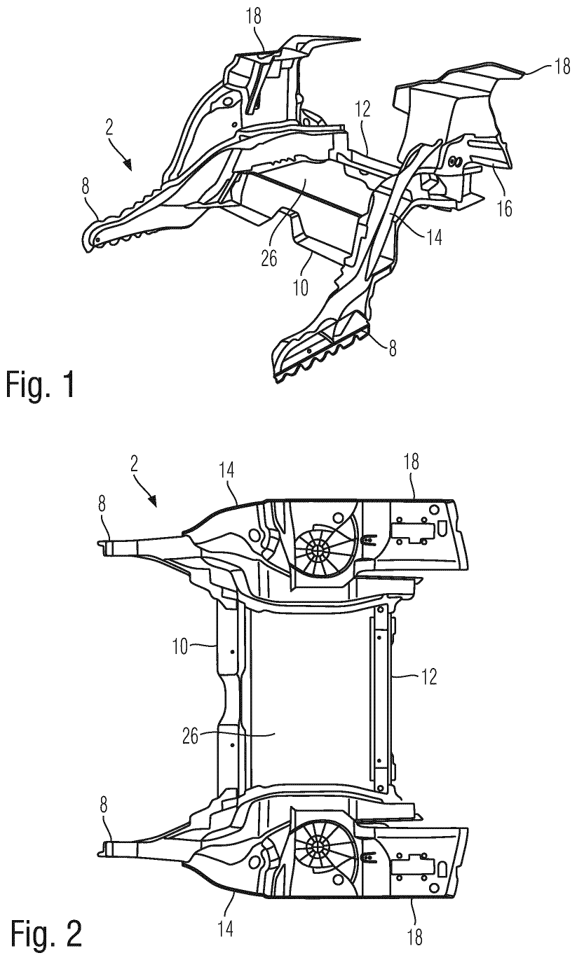

A first rear structure 2 for a motor vehicle is illustrated in FIGS. 1 and 2. The first rear structure 2 is a single-piece die-cast component, comprising two longitudinal members 8, a front crossmember 10, a rear crossmember 12, two front wheelhouse subregions 14, two rear wheelhouse subregions 16 and two rear spring supports 18.

In a functional installation state of the first rear structure 2 on the motor vehicle, the two longitudinal members 8 extend in the motor vehicle longitudinal direction and the front crossmember 10 and the rear crossmember 12 extend in the motor vehicle transverse direction. The front crossmember 10 and the rear crossmember 12 thus extend orthogonally to the longitudinal members 8.

At a first end, the front crossmember 10 and the rear crossmember 12 each adjoin a first one of the longitudinal members 8. At the second end, which is situated opposite the first end in the motor vehicle transverse direction, the front crossmember 10 and the rear crossmember 12 adjoin the second of the longitudinal members 8.

The front crossmember 10, the rear crossmember 12 and the longitudinal members 8 thus define a first cutout 26. As can be seen in particular from FIG. 2, the first cutout 26 has a virtually rectangular shape in the top view, that is to say when considered from above.

A luggage compartment floor of the motor vehicle can be arranged in the first cutout 26.

The first cutout 26 is open to the top and bottom in the motor vehicle vertical direction.

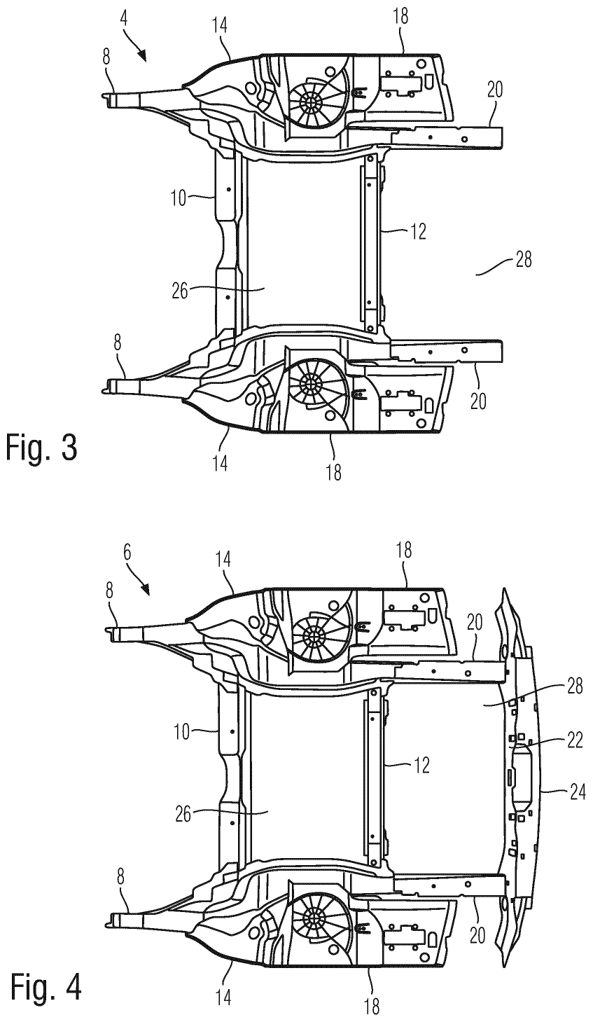

FIG. 3 shows a second rear structure 4 for a motor vehicle. The second rear structure 4 substantially corresponds to the first rear structure 2 illustrated in FIGS. 1 and 2. Therefore, only the distinguishing features will be explained below. For all further features, the above statements regarding the first rear structure 2 apply.

In addition to the two longitudinal members 8, the front crossmember 10, the rear crossmember 12, the two front wheelhouse subregions 14, the two rear wheelhouse subregions 16 and the two rear spring supports 18, the second rear structure 4 comprises two extensions 20 of the longitudinal members 8.

The extensions 20 of the longitudinal members 8 extend in the motor vehicle longitudinal direction and each adjoin a respective one of the longitudinal members 8 at their end sides in the motor vehicle longitudinal direction.

Together with the rear crossmember 12, the extensions 20 of the longitudinal members 8 define a second cutout 28. For example, a luggage compartment tray can be arranged in the second cutout 28.

The second cutout 28 is thus delimited to the front in the motor vehicle longitudinal direction by the crossmember 12 and laterally in the motor vehicle transverse direction by the longitudinal members 8. The second cutout 28 is open to the rear in the motor vehicle longitudinal direction and to the top and bottom in the motor vehicle vertical direction.

The second cutout 28 is situated behind the first cutout 26 in the motor vehicle longitudinal direction.

The extensions 20 of the longitudinal members 8 can each have a connection element (not shown) to the rear in the motor vehicle longitudinal direction. A rear covering support (not shown) of the motor vehicle can be fixable to the connection elements.

A third rear structure 6 for a motor vehicle is illustrated in FIG. 4. The third rear structure 6 corresponds substantially to the second rear structure 4 illustrated in FIG. 3. Therefore, only the distinguishing features will be explained below. For all further features, the above statements regarding the second rear structure 4 apply.

In addition to the two longitudinal members 8, the front crossmember 10, the rear crossmember 12, the two front wheelhouse subregions 14, the two rear wheelhouse subregions 16, the two rear spring supports 18 and the two extensions 20 of the longitudinal members 8, the third rear structure 6 comprises a rear covering support 22 and a rear covering 24.

The rear covering support 22 extends in the motor vehicle transverse direction and adjoins a rear end of the extensions 20 of the longitudinal members 8 in the motor vehicle longitudinal direction. The rear covering support 22 thus connects the extensions 20 of the longitudinal members 8 to one another and delimits the second cutout 28 to the rear in the motor vehicle longitudinal direction.

The rear covering 24 in turn adjoins the rear covering support 22 to the rear in the motor vehicle longitudinal direction.

It is also contemplated that the rear covering 24 is not a constituent part of the third rear structure 6, that is to say is not a constituent part of the integral component, but is fixed to the rear covering support 22 via connecting elements.

### LIST OF REFERENCE SIGNS

2 First rear structure according to the invention
4 Second rear structure according to the invention
6 Third rear structure according to the invention
8 Longitudinal member
10 Front crossmember
12 Rear crossmember
14 Front wheelhouse subregion
16 Rear wheelhouse subregion
18 Rear spring support
20 Extension
22 Rear covering support
24 Rear covering
26 First cutout
28 Second cutout

1.-10. (canceled)

11. A rear structure for a motor vehicle, comprising:
two longitudinal members;
a front crossmember; and
a rear crossmember, wherein
the front crossmember and the rear crossmember each connect the two longitudinal members to one another, and
the rear structure is a single-piece die-cast component.

12. The rear structure according to claim 11, wherein
the rear structure is an aluminum die-cast component.

13. The rear structure according to claim 11, wherein
the two longitudinal members, the front crossmember and the rear crossmember define a first cutout in which a luggage compartment floor is arrangeable.

14. The rear structure according to claim 11, further comprising:
extensions of the two longitudinal members which, in a functional installation state of the rear structure on the motor vehicle, each adjoin a respective one of the two longitudinal members to the rear in a motor vehicle longitudinal direction, wherein
the extensions of the two longitudinal members and the rear crossmember define a second cutout in which a luggage compartment tray of the motor vehicle is arrangeable.

15. The rear structure according to claim 14, wherein
the extensions of the two longitudinal members each comprise a connection element to which a rear covering support of the motor vehicle is fixable and connects the extensions of the two longitudinal members to one another, and by which the second cutout is delimited to the rear in the motor vehicle longitudinal direction.

16. The rear structure according to claim 11, further comprising:
extensions of the two longitudinal members which, in a functional installation state of the rear structure on the motor vehicle, each adjoin a respective one of the two longitudinal members to the rear in a motor vehicle longitudinal direction; and
a rear covering support which connects the extensions of the two longitudinal members to one another, wherein
the extensions of the two longitudinal members, the rear crossmember and the rear covering support define a second cutout in which a luggage compartment tray of the motor vehicle is arrange able.

17. The rear structure according to claim 11, further comprising:
a rear covering, spring supports and/or at least parts of wheelhouses.

18. The rear structure according to claim 11, wherein
the rear structure is numerically structure-optimized.

19. The rear structure according to claim 11, wherein
the rear structure is shape-optimized, parameter-optimized, and/or topology-optimized.

20. A motor vehicle, comprising:
a rear structure, the rear structure comprising:
two longitudinal members;
a front crossmember; and
a rear crossmember, wherein
the front crossmember and the rear crossmember each connect the two longitudinal members to one another, and
the rear structure is a single-piece die-cast component.
